(19) United States
(12) Patent Application Publication
(10) Pub. No.: US 2021/0124240 A1
(43) Pub. Date: Apr. 29, 2021

(54) LENS HOOD FOR A CINEMATOGRAPHIC CAMERA SYSTEM

(71) Applicant: ARNOLD & RICHTER CINE TECHNIK GMBH & CO. BETRIEBS KG, Munich (DE)

(72) Inventor: Jan KASTER, Feldafing (DE)

(73) Assignee: ARNOLD & RICHTER CINE TECHNIK GMBH & CO. BETRIEBS KG, Munich (DE)

(21) Appl. No.: 17/078,784

(22) Filed: Oct. 23, 2020

(30) Foreign Application Priority Data
Oct. 23, 2019 (DE) 10 2019 128 573.9

(51) Int. Cl. G03B 11/04; G02B 7/02; H04N 5/225; H04N 5/232

(52) U.S. Cl. CPC G03B 11/045; H04N 5/23245; H04N 5/2254; G02B 7/02

(57) ABSTRACT

A lens hood is used with a camera unit of a camera system for capturing still or motion images. The camera unit contains an image sensor and an objective lens mount arranged along an optical axis of the camera system. The objective lens mount guides an image-generating light beam from the environment including the object to a sensor surface of the image sensor. The lens hood is positioned on the objective lens mount or between the objective lens mount and the image sensor. The lens hood has a frame structure having frame structure portions and an aperture for the image-generating light beam. The aperture is formed by one of the frame structure portions. A circumferential extent of the aperture formed by the frame structure portion is a closed polygonal chain including a plurality of polygon segments, extending perpendicularly to the optical axis, each having at least three edges.

### PRIORITY

The present patent application claims priority of German patent application DE 10 2019 128 573.9 filed on 23 Oct. 2029. The content of DE 10 2019 128 573.9 is herewith incorporated in its entirety.

### TECHNICAL FIELD

The present specification relates to embodiments of a lens hood for a camera system, in particular a cinematographic camera system. The present specification further relates to embodiments of a camera system having a lens hood, in particular to embodiments of a cinematographic camera system having a lens hood.

### BACKGROUND

Document WO 2006/012859 A2 discloses, for example, a cinematographic camera system.

Such a camera system comprises a camera unit for capturing still and/or motion images of an object, wherein the camera unit has an optical unit having at least one objective lens and an image sensor. The light is captured via the objective lens and guided to the image sensor. The image sensor is connected to an image signal evaluation unit that reads the image sensor and produces as a result digital data that are indicative of the still or motion images.

A camera system or the optical system of the camera system is typically also equipped with one or a plurality of stops.

For example, a lens hood reduces stray light in a detection region, that is to say in a region in front of the image sensor.

A field stop delimits an image-generating light beam to a desired detection region, wherein lens hoods can also be embodied in the form of field stops.

What is known as an aperture stop defines, for example, the numerical aperture (NA) and/or a T/# (for objective lenses for recording motion images, the use of what is known as a T-stop or a T/# has become established. The latter is—like the F/#—a measure of the image NA, but also of the spectral transmittance. With it, the number has more meaning for the actual exposure of the sensor). The aperture stop, for example, is located in the objective lens at the location where chief rays intersect the optical axis.

The term “image-generating light beam” is here (as usual) understood to mean the entire spatial field distribution that converges to form an image.

It is desirable to have a lens hood for a camera system that brings about advantages with respect to the image generation.

### DESCRIPTION

Proceeding from this, the subjects of the independent claims are proposed. Features of a few exemplary embodiments are stated in the dependent claims. The features of the dependent claims can be combined with one another to form further embodiments, unless expressly stated otherwise.

According to a first aspect, a lens hood for a camera unit of a camera system for capturing still and/or motion images of an object is proposed. The camera unit contains an image sensor and an objective lens mount that are arranged along an optical axis of the camera system. Using an objective lens, the objective lens mount guides an image-generating light beam from the environment comprising the object to a sensor surface of the image sensor. The lens hood is embodied for an arrangement, with respect to the optical axis, on the objective lens mount or between the objective lens mount and the image sensor. The lens hood has a frame structure having a number of frame structure portions and an aperture for the image-generating light beam, wherein the aperture is formed by one of the number of frame structure portions. A circumferential extent of the aperture formed by the frame structure portion is a closed polygonal chain including a plurality of polygon segments, extending perpendicularly to the optical axis, with in each case at least three edges.

A second aspect is formed by a camera system having a camera unit equipped with a lens hood of the first aspect.

Reference will be made below to both aforementioned aspects.

Owing to the edges of the polygonal chain extending rectilinearly, the lens hood focuses little to no stray light, neither directly nor on account of multiple reflections, and therefore does not increase the irradiance of stray light in the image.

Further features and advantages will become clear to a person skilled in the art upon studying the following detailed description and upon seeing the accompanying drawings.

### BRIEF DESCRIPTION OF THE DRAWINGS

The parts shown in the drawings are not necessarily to scale, and the emphasis is rather on illustrating principles of the invention. Furthermore, identical reference signs in the drawings relate to mutually corresponding parts. In the drawings:

FIG. 1 illustrates schematically and by way of example a camera system according to one or more embodiments;

FIG. 2 illustrates schematically and by way of example an approach for forming the circumferential extent of an aperture of a lens hood according to one or more embodiments; and

FIG. 3 illustrates schematically and by way of example a plan view and a perspective view of a lens hood according to one or more embodiments;

FIG. 4 illustrates schematically and by way of example a perspective view of a lens hood according to one or more embodiments, mounted on an objective lens mount of a camera system; and

FIG. 5 illustrates schematically and by way of example a plan view of a lens hood according to one or more embodiments.

### DETAILED DESCRIPTION

In the following detailed description, reference is made to the accompanying drawings in which it is shown, by illustrating specific embodiments, how the invention can be implemented in practice.

Reference will now be made in detail to different embodiments and to one or more examples that are illustrated in the figures. Each example is presented in an illustrative manner and should not be construed as a restriction of the invention. For example, illustrated features or features that are described as part of an embodiment can be applied to or in conjunction with other embodiments to bring about yet another embodiment. The present invention is intended to comprise such modifications and variations. The examples are described with the use of a specific language that should not be interpreted as restricting the scope of protection of the attached claims. The drawings are not a true-to-scale reproduction and serve merely for illustration purposes. For better comprehension, the same elements have been denoted by the same references in the various drawings unless specified otherwise.

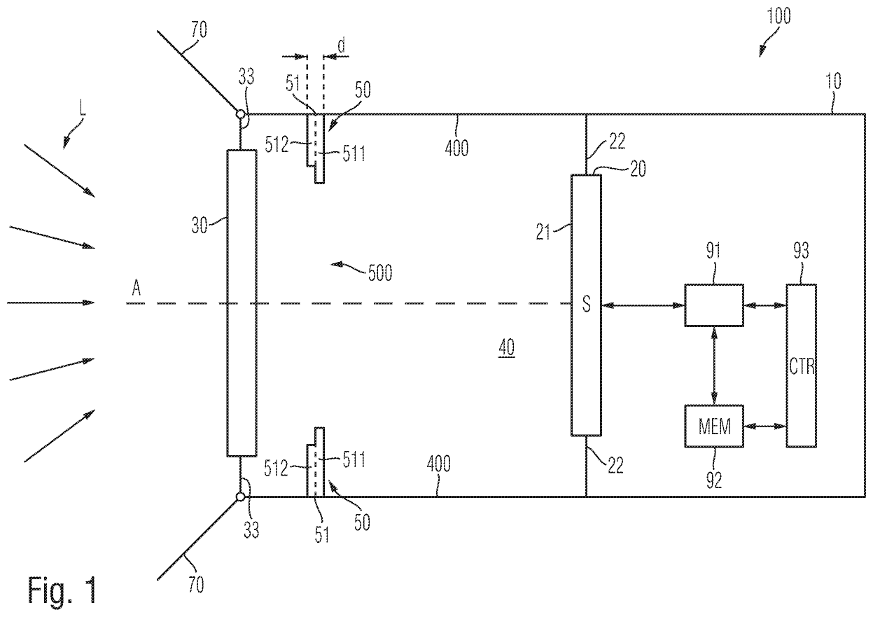

FIG. 1 shows schematically and by way of example an embodiment of a camera system 100.

The camera system 100 described here is embodied for example to be used for cinematography, that is to say for example for recording a documentary, a movie, a show, other studio presentations, and the like. The camera system 100 can be a cinematographic camera system 100. Alternatively or in addition to the recording of motion images, the camera system 100 according to one embodiment is embodied to record still images.

However, the present invention is not limited to cinematographic camera systems.

As an alternative, the camera system 100 can be, for example, a medical camera system, for example for generating medical image recordings.

In principle, all camera systems, in particular camera optics systems, that can be equipped with a lens hood (see reference sign 50), described here in detail, may be considered. This includes for example camera systems for photography and also camera systems for microscopy.

A camera unit 10 of the camera system 100 comprises, for example, the usual components of a camera, which are not illustrated in more detail in the drawings, or are illustrated only schematically.

The components of the camera system 100 include, for example, a camera optical unit with at least one objective lens mount 30 (to which an objective lens can be attached), a compendium 70, at least one image sensor 20 of the camera unit 10, digital signal processing means, e.g. comprising a read unit 91 that reads the image sensor 20 and feeds corresponding data to a digital memory 92, and a controller 93 controlling the read unit 91 and/or the memory 92, a user interface, communication interfaces (not illustrated), etc.

The details of exemplary designs of the components 91, 92, 93, which are mounted downstream of the image sensor 20, will not be discussed further here because a person skilled in the art is familiar with the basic functions thereof.

The camera unit 10 can be embodied to be used for cinematography, that is to say for example for recording a still image or motion images, for example of a documentary, of a movie, of a show, of other studio presentations, and the like. The camera unit 10 can be a cinematographic camera unit 10. In a different embodiment, the camera unit 10 is embodied for medical purposes, for example for producing images or image sequences of an object (e.g. a piece of tissue) or the like. As already described above, in principle all camera systems may be considered for being equipped with the lens hood 50 that is described here. This includes, as stated, for example camera systems for photography and also camera systems for microscopy.

The camera system 100 can be a digital camera system in which the image data are generated with the aid of a digital image sensor 20. However, it is also within the scope of the invention that the image sensor 20 is present in the form of an analog film as is still used on occasion today. In a camera system of that design, the images are thus recorded in an analog manner.

However, the image sensor 20 is typically embodied in the form of a digital image sensor, for example in the form of a semiconductor chip having a multiplicity of pixels, such as a CMOS or CCD image sensor. Such an image sensor 20 typically has a substantially rectangular sensor surface 21.

The camera system 100 comprises an image space 40 (which could also be referred to as objective lens space) into which an objective lens (not illustrated) attached to the objective lens mount 30 couples an image-generating light beam L from the environment comprising the object and guides it to the image sensor 20, wherein further optical components (in addition to the ones that are not shown here), such as one or more filters, one or more lens elements, one or more stops, and the like, can be provided between the objective lens mount 30 and the image sensor 20.

It is to be understood that different objective lenses can be attached to the objective lens mount 30 of the camera unit 10. The components compendium 70, objective lens mount 30 (and objective lens), and camera unit 10 can thus be produced as separate components. For example, compendia 70 having different designs can also be coupled to the objective lens mount 30, as can objective lenses 30 having different designs, and for example different camera units 10 can be coupled to the same objective lens mount 30. The camera system 100 can thus have a modular design.

For coupling the objective lens to the camera unit 10, the objective lens mount 30 is provided, which can likewise constitute a constituent part of the camera system 100. The objective lens mount 30 is embodied to form a mechanical interface between the objective lens and the camera unit 10. Objective lenses of different manufacturers frequently have different mount geometries on the side of the objective lens, which is why the camera-side mounts are interchangeable or modifiable with adapters (in the professional cinematography field and in the photography field, intermediate adapters are used on occasion).

The image sensor 20 of the camera unit 10 has the sensor surface 21 facing into the image space 40. The sensor surface 21 can be surrounded by a sensor frame 22, wherein the sensor frame 22 can likewise delimit the image space 40 and adjoins an inner wall 400 of the image space 40 so that it is flush therewith, for example, as is illustrated schematically in FIG. 1.

On the other side, the image space 40 can also be delimited by the objective lens mount 30 (or by an objective lens that is attached thereto). The objective lens mount 30 can be supported by an objective lens frame 33, which can likewise delimit the image space 40. Moreover, the image space 40 is also delimited by the inner wall 400.

The compendium 70 (which is also referred to as matte box) can be coupled to the objective lens frame 33 (or to another location of the camera unit 10 or of the camera system 100).

FIG. 1 illustrates the image space 40 as being substantially cylindrical, wherein in another embodiment the image space 40 has the shape of a cone section tapering in the direction of or counter to the direction of light incidence. Other geometric designs of the image space 40 are possible.

FIG. 1 shows a simplified schematic illustration of the camera system 100. The more detailed design of the camera system 100, as far as it concerns the components 70, 30, 20 and 91-93, is less relevant here. The basic principles of said components are known to a person skilled in the art, and the present invention does not deviate therefrom.

Aside from the ambient light L being coupled in by way of the objective lens on the objective lens mount 30, the image space 40 can be embodied to be substantially lightproof.

The camera system 100, which comprises the camera unit 10, for capturing still and/or motion images consequently includes in particular the following components, which are arranged along the optical axis A of the camera system 100: the (for example digital) image sensor 20 and the objective lens mount 30, which guides the image-generating light beam L from the environment comprising the object to the sensor surface 21 of the image sensor 20 (by means of an objective lens attached to the objective lens mount 30).

In accordance with the embodiments described here, a lens hood 50 that is embodied for an arrangement, with respect to the optical axis A, either on the objective lens mount 30 (e.g. also in the objective lens mount 30) or between the objective lens mount 30 and the image sensor 20 (as is illustrated schematically and by way of example in FIG. 1) is furthermore provided. The variant “arrangement on the objective lens mount” here also comprises an arrangement in an or on an objective lens that is to be attached to the objective lens mount 30.

Some of the embodiments of the lens hood 50 described further below proceed from the following considerations:

Previously known lens hoods typically have circular cutouts in the region of the objective lens mount in the necessary format dimensions at the corresponding axial position in the optical system. In the vicinity of the sensor, the stops are typically almost—adapted to the shape of the sensor surface—rectangular, and in the vicinity of the pupils of the optics system, the cross sections of the stops are typically circular.

The general function of lens hoods and field stops is to delimit the physical, image-generating light beam to the relevant region, what is known as the “focal plane array” (FPA) region, and to avoid or reduce the irradiation of optomechanics, optoelectronics, etc., for example to increase the macro contrast in the image by reducing interfering stray light (also known as “veiling glare”). If the stops are adapted in their cross sections in an obvious manner to the shape of the image-generating beam, the lens hoods have curved segments, for example in the shape of cone sections (circular, elliptical/parabolic, etc.).

However, this has the disadvantage that stray light that is reflected at aperture edges and the faces thereof can be focused into the FPA region. Owing to the focusing, the irradiance and thus the relative visibility of the stray light increases. This undesirable effect generally has a high light incidence angle sensitivity (flickering stray light in the case of camera movements) and is therefore clearly perceivable and highly undesirable.

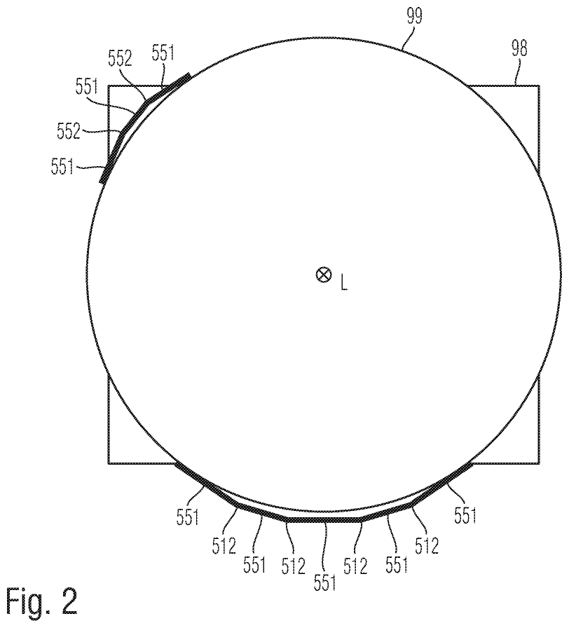

Rather than designing the lens hoods in the shape of the image-generating beam cross section 99 or of a rectangle according to the shape 98 of a sensor surface, cone section segments are approximated in polygon segments having in each case at least three edges 551 that transition into one another at corners 552 of the polygonal chain, as is illustrated in FIG. 2, according to some of the embodiments described here.

It is here expedient to keep the number of the polygon segments as small as possible, for example according to a system-specific and position-specific compromise between azimuthal field delimitation and number of polygon segments. According to some embodiments, chamfers and radii are dispensed with as far as possible, for example by selecting a corresponding manufacturing method with a small tool diameter, for example wire EDM, jet cutting (e.g. laser), etching (e.g. with acids or ion or electron beams) or forming, such as injection molding or additive manufacturing methods (for example laser sintering/melting, stereolithography, etc.). External edges can remain sharp-edged and burr-free.

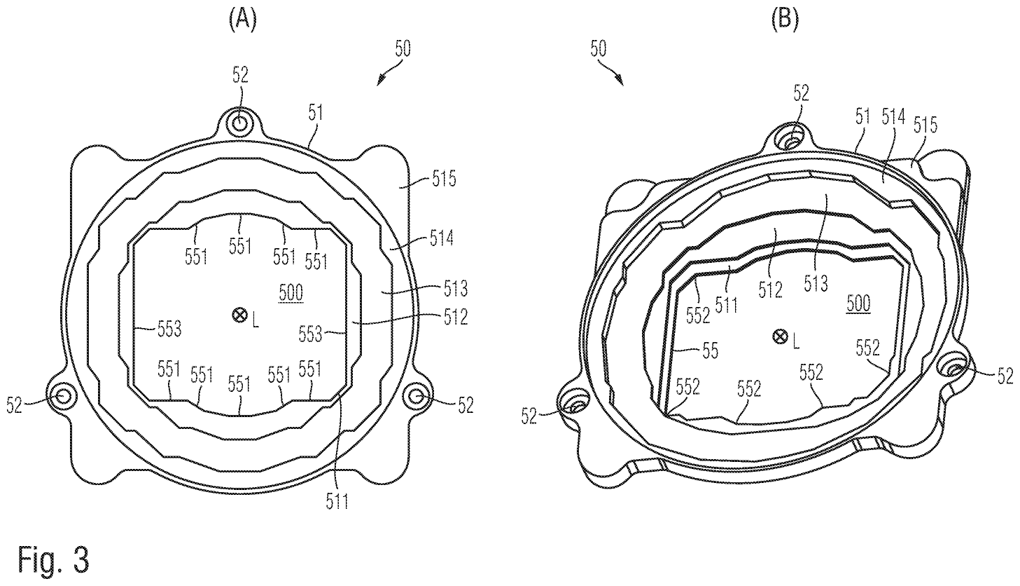

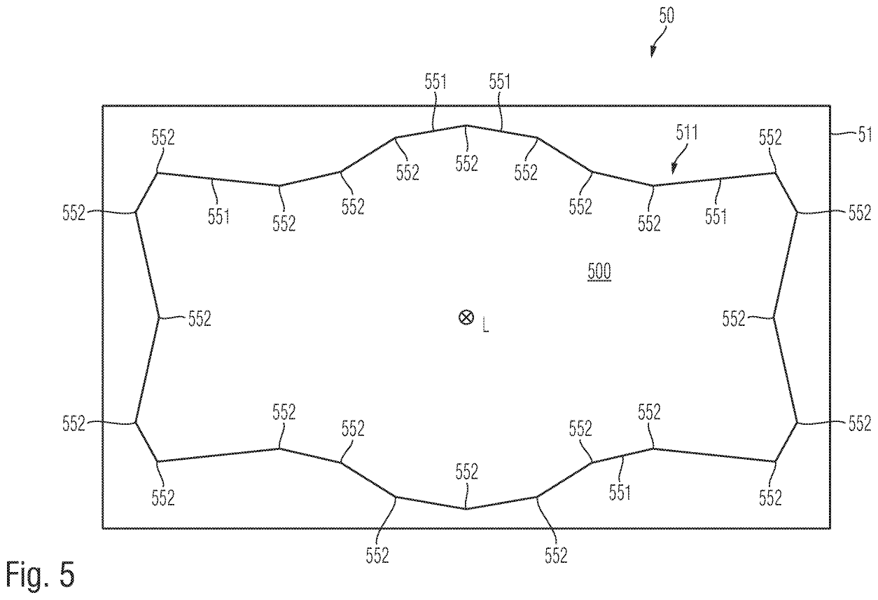

FIGS. 3 and 5 illustrate embodiments of the lens hood 50:

The lens hood 50 has a frame structure 51 with a number of frame structure portions 511-515. According to one embodiment, only one frame structure portion 511 is provided (see FIG. 5). According to another embodiment, a plurality of frame structure portions 511, 512, 513, 514, 515 are provided, for example five portions 511-515, as is illustrated in FIG. 3. If a plurality of frame structure portions 511, 512, 513, 514, 515 are provided, they can be arranged in a multilayer composite construction, as is described for example in the as yet unpublished patent application DE 10 2019 112 679.7 by this applicant, and the entire disclosure content thereof is hereby incorporated in the present patent application. The frame structure portions 511, 512, 513, 514, 515 can consequently each be embodied as a layer that are arranged in the manner of a sandwich and differ from one another at least in one of the following parameters: material; layer thickness; size of the opening for the image-generating light beam. The frame structure portions 511, 512, 513, 514, 515 can be formed in each case from a monolithic layer. For example, the frame structure portions 511, 512, 513, 514, 515 are connected to one another by adhesive bonding, soldering, latching and/or welding. An innermost frame structure portion 511 of the frame structure 51, or a frame structure portion 511 closest to the image sensor 20, can be very thin, for example form the thinnest of all the layer-type frame structure portions 511, 512, 513, 514, 515. The innermost frame structure portion 511 of the frame structure 51, or the frame structure portion 511 closest to the image sensor 20, has the smallest opening for the image-generating light beam L as compared to the remaining frame structure portions 512, 513, 514, 515.

The frame structure 51 according to another embodiment can also be embodied to be monolithic overall. The frame structure 51, illustrated in FIG. 3, with the portions 511-515 with the openings that increase in size in the direction of the objective lens mount may be expedient even in this case. The frame structure 51 illustrated in FIG. 3 with the portions 511-515, arranged in a layer-type manner, with the openings that increase in size in the direction of the objective lens mount forms for example “pockets” in which stray light undergoes multiple reflections at absorbing surfaces. In general terms: The greater the number of reflections is in a stray light path, the more pronounced is the attenuation thereof. The effective reflectance of a path is Rⁿ, with R denoting the reflectance and n denoting the number of reflections. The axial distances between the portions 511-515 can further be selected such that the number of reflections is maximized before stray light travels back into the optics system or is incident on the sensor surface 21.

However, it should be emphasized here that the formation of “pockets” illustrated in FIG. 3 by way of the portions 511-515, arranged in a layer-type manner, with the openings that increase in size in the direction of the objective lens mount is only one exemplary variant. As stated, according to another embodiment, the frame structure 51 can also comprise only one frame structure portion 511 (see FIG. 5), or the potential further frame structure portions are arranged in a different manner than is illustrated in FIG. 3.

The lens hood 50 thus has an aperture 500 for the image-generating light beam L, wherein the aperture 500 is formed by one of the number of frame structure portions, e.g. by the frame structure portion 511 located closest to the sensor 20. For example, the aperture 500 is formed only by this frame structure portion 511. In addition, this frame structure portion 511 can be embodied monolithically (in one part/in one piece). According to another embodiment, the frame structure portion 511 that forms the closed polygonal chain is formed from multiple parts, wherein the plurality of parts of the frame structure portion 511 together form the aperture 500 and are not offset with respect to one another in a direction parallel to the optical axis A. The aperture 500 is thus for example not defined by a plurality of frame structure portions and/or a plurality of parts that would be offset with respect to one another in a direction parallel to the optical axis A.

A circumferential extent 55 of the aperture 500 formed by the frame structure portion 511 is a closed polygonal chain including a plurality of polygon segments, extending perpendicularly to the optical axis A, with in each case at least three edges 551.

The closed polygonal chain includes for example at least 8 edges 551, for example 16 edges 551. At least each of the half of all edges 551 of the closed polygonal chain has for example a length of a few mm. The respective edge length is selected for example in dependence on the axial distance from the sensor 20, the desired polygon degree of the circumferential extent 55 and/or the radial position of the relevant edge.

The polygon segments are not offset with respect to one another in a direction parallel to the optical axis A. For example, each edge 551, 553 of the polygonal chain has the same thickness, which is less than 50 μm, for example. The thickness of the frame structure portion 511 forming the closed polygonal chain can thus be less than 50 μm, even less than 25 μm, for example.

The frame structure 51 according to one embodiment has a thickness d that is less than 100 μm. The thickness d is for example equal to the sum of the thicknesses of the frame structure portions 511-515. According to one example, the frame structure 51 has a thickness d ranging from 50 μm to 100 μm, and/or the thickness of the frame structure portion 511 forming the closed polygonal chain ranges from 10 μm to 25 μm.

The frame structure 51 has on its outer circumferential extent attachment means 52, for example cutouts provided with threads, in which screws engage for example to bring about an attachment to the objective lens mount 30 or another location between the objective lens mount 30 and the sensor 20.

As has already been mentioned, the frame structure portion 511 forming the closed polygonal chain is, according to one embodiment, a monolithic frame structure portion 511.

According to one embodiment, the closed polygonal chain has no chamfers, radii or curved edge transitions, but is formed only by the edges 551, 553, which transition into one another at corners 552 of the polygonal chain.

In the illustrated embodiment as per FIG. 3, the plurality of polygon segments is two (a first polygon segment at the “top” and a second polygon segment at the “bottom”). The two polygon segments are of the same type and are embodied to lie opposite one another and are linked by two edges 553 that are located opposite one another (“right” and “left”). The two edges 553 that lie opposite one another have the same length, which is greater than the length of each of the edges 551 of the two polygon segments. This is an example in which the number of polygon segments is low, in accordance with a system-specific and position-specific compromise between azimuthal field delimitation and number of polygon segments. According to another example, for example when using the lens hood 50 in a system with a tilted optical unit or in an off-axis system, possibly with asymmetric freeform optical units, the edges 553 would not necessarily have the same length; rather, such portions of the polygonal chain could also be reasonably “polygonized” there.

In more general terms, said compromise can be implemented for example by providing N*M edges 551, 553 extending parallel to one another overall to form the closed polygonal chain, with M being two and N being an integer greater than or equal to four. Furthermore, the respectively two edges 551, 553 that extend parallel to each other can have the same length. In other words, the polygonal chain includes for each edge an edge that extends parallel thereto and is of equal length.

In principle, however, the closed polygonal chain can be formed arbitrarily to be optimized specifically to the respective application of the frame structure portion 511. FIG. 5 shows a variant in that vein, where for example no edges 551 that are parallel to one another are provided. The tilting of the edges can be advantageous for example to guide reflections at the edges in a targeted manner into light traps or other highly absorbing regions.

The frame structure 51 is manufactured for example by one of the following manufacturing methods:
wire EDM;
jet cutting, e.g. using laser;
etching;
injection molding and/or milling method;
additive manufacturing methods, e.g. 3D print.

The frame structure 51 consists for example of a metal sheet; in particular, the frame structure portion 511 can be a metal sheet provided with a cutout forming the aperture 500.

The straight lines of the edges 511, 513 of the closed polygonal chain of the aperture 500 according to one embodiment focus little to no stray light (neither directly nor by way of multiple reflections with further surfaces of the system) and thus decrease the visibility of stray light. Diffraction effects due to surface structures can moreover be kept low by deliberately selected manufacturing and coating methods.

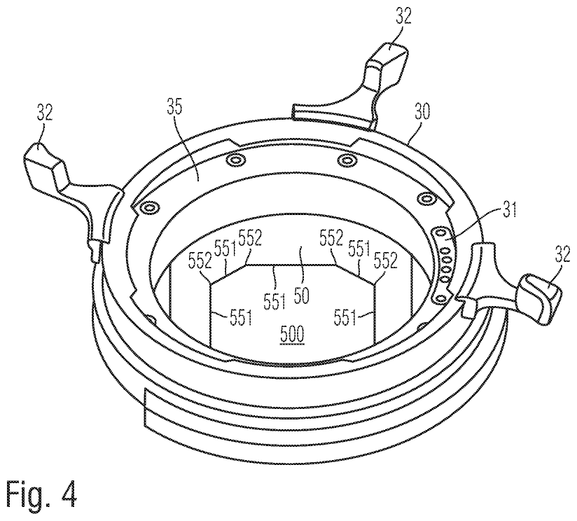

Finally, FIG. 4 shows by way of example the attachment of the lens hood 50 to the side of the objective lens mount 30 that faces the sensor 20. An objective lens is attached on the side of the objective lens mount 30 that faces the environment. For example, a bayonet lock 35 is provided for this purpose, which can be locked or released via operating elements 32. A communication and control interface 35 establishes a communication-technical coupling to the controller 93, with the result that the controller 93 can act in a control-technical manner on the objective lens attached to the objective lens mount 30.

[86] The terms “having,” “containing,” “including,” “comprising,” and similar terms, as they are used here, are open terms that indicate the presence of stated elements or features without excluding additional elements or features.

In view of the above range of variations and applications, it is noted that the present invention is not restricted by the aforementioned description and is not restricted either by the accompanying drawings. Rather, the present invention is restricted merely by the following claims and their legal equivalents.

1. A lens hood for a camera unit of a camera system for capturing still and/or motion images of an object, wherein the camera unit contains an image sensor and an objective lens mount that are arranged along an optical axis of the camera system, and wherein the objective lens mount guides an image-generating light beam from the environment comprising the object to a sensor surface of the image sensor using an objective lens, and wherein the lens hood is embodied for an arrangement, with respect to the optical axis, on the objective lens mount or between the objective lens mount and the image sensor and has:
a frame structure with a number of frame structure portions; and
an aperture for the image-generating light beam, wherein:
the aperture is formed by one of the number of frame structure portions; and
a circumferential extent of the aperture formed by the frame structure portion is a closed polygonal chain including a plurality of polygon segments, extending perpendicularly to the optical axis, with in each case at least three edges.

2. The lens hood as claimed in claim 1, wherein the polygon segments are not offset with respect to one another in a direction parallel to the optical axis.

3. The lens hood as claimed in claim 1, wherein the frame structure portion forming the closed polygonal chain is a monolithic frame structure portion.

4. The lens hood as claimed in claim 1, wherein the closed polygonal chain has no chamfers, radii or curved edge transitions, but is formed only by the edges which transition into one another at corners of the polygonal chain.

5. The lens hood as claimed in claim 1, wherein:
the plurality of polygon segments is two; and
the two polygon segments are of the same type and are embodied to lie opposite one another and are linked by two edges that are located opposite one another.

6. The lens hood as claimed in claim 5, wherein the two edges that lie opposite one another have the same length, which is greater than the length of each of the edges of the two polygon segments.

7. The lens hood as claimed in claim 1, wherein:
N*M edges extending parallel to one another overall are provided to form the closed polygonal chain; and
M is two and N is an integer greater than or equal to four.

8. The lens hood as claimed in claim 7, wherein the respectively two edges that extend parallel to each other have the same length.

9. The lens hood as claimed in claim 1, wherein the frame structure is embodied monolithically.

10. The lens hood as claimed in claim 1, wherein a thickness of the frame structure parallel to the optical axis is less than 100 μm.

11. The lens hood as claimed in claim 1, wherein a thickness of the frame structure portion forming the closed polygonal chain is less than 50 μm.

12. The lens hood as claimed in claim 1, wherein the frame structure is manufactured by one of the following manufacturing methods:
wire EDM;
jet cutting, e.g. using laser;
etching;
injection molding and/or milling method; and
additive manufacturing methods, e.g. 3D print.

13. The lens hood as claimed in claim 1, wherein the frame structure consists of a metal sheet.

14. A camera system for capturing still and/or motion images of an object, comprising:
a camera unit with an image sensor and an objective lens mount that are arranged along an optical axis of the camera system, wherein:
the objective lens mount guides an image-generating light beam from the environment comprising the object to a sensor surface of the image sensor using an objective lens, and
a lens hood that is embodied for an arrangement, with respect to the optical axis, on the objective lens mount or between the objective lens mount and the image sensor, the lens hood having:
a frame structure with a number of frame structure portions; and
an aperture for the image-generating light beam, wherein:
the aperture is formed by one of the number of frame structure portions; and
a circumferential extent of the aperture formed by the frame structure portion is a closed polygonal chain including a plurality of polygon segments, extending perpendicularly to the optical axis, with in each case at least three edges.

15. The camera system as claimed in claim 14, wherein the lens hood is arranged between the objective lens mount and the image sensor.
